(19) United States
(12) Patent Application Publication
(10) Pub. No.: US 2026/0046001 A1
(43) Pub. Date: Feb. 12, 2026

(54) CONTROL CHANNEL CYCLIC DELAY DIVERSITY SCHEME

(71) Applicant: QUALCOMM Incorporated, San Diego, CA (US)

(72) Inventors: Weimin DUAN, San Diego, CA (US); Gabi SARKIS, San Diego, CA (US); Hyojin LEE, San Diego, CA (US); Jing JIANG, San Diego, CA (US)

(21) Appl. No.: 18/799,695

(22) Filed: Aug. 9, 2024

(51) Int. Cl. H04B 7/06; H04W 72/231

(52) U.S. Cl. CPC H04B 7/0671; H04W 72/231

(57) ABSTRACT

Methods, systems, and devices for wireless communications are described. A network entity may indicate a range of values for a cyclic delay diversity (CDD) parameter associated with a channel to a UE. The UE may select a CDD value from the range of values based on one or more measurements, a configuration, or both, associated with the channel. The network entity may apply a cyclic to the channel according to a CDD value from the range of values, and may transmit, according to the applied cyclic delay, signaling to the UE via the channel. In some cases, the UE may receive the second control signaling according to the CDD value selected by the UE. The network entity may indicate the range of values via one or more techniques, and the range of values may be associated with a set of channel conditions, control resources, or both.

### FIELD OF TECHNOLOGY

The following relates to wireless communications, including control channel cyclic delay diversity scheme.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include transmitting first control signaling that indicates a range of values for a cyclic delay parameter (cyclic delay diversity (CDD) parameter) associated with a control channel between the network entity and a user equipment (UE), applying a cyclic delay to the control channel using a value of the CDD parameter, where the value is within the range of values for the CDD parameter, and transmitting, via the control channel and based on the applied cyclic delay, second control signaling.

A network entity for wireless communications is described. The network entity may include one or more memories storing processor executable code, and one or more processors coupled with the one or more memories. The one or more processors may individually or collectively be operable to execute the code to cause the network entity to transmit first control signaling that indicates a range of values for a CDD parameter associated with a control channel between the network entity and a UE, apply a cyclic delay to the control channel using a value of the CDD parameter, where the value is within the range of values for the CDD parameter, and transmit, via the control channel and based on the applied cyclic delay, second control signaling.

Another network entity for wireless communications is described. The network entity may include means for transmitting first control signaling that indicates a range of values for a CDD parameter associated with a control channel between the network entity and a UE, means for applying a cyclic delay to the control channel using a value of the CDD parameter, where the value is within the range of values for the CDD parameter, and means for transmitting, via the control channel and based on the applied cyclic delay, second control signaling.

A non-transitory computer-readable medium storing code for wireless communications is described. The code may include instructions executable by one or more processors to transmit first control signaling that indicates a range of values for a CDD parameter associated with a control channel between the network entity and a UE, apply a cyclic delay to the control channel using a value of the CDD parameter, where the value is within the range of values for the CDD parameter, and transmit, via the control channel and based on the applied cyclic delay, second control signaling.

In some examples of the method, network entities, and non-transitory computer-readable medium described herein, transmitting the first control signaling that indicates the range of values may include operations, features, means, or instructions for transmitting an indication of a lower bound value, an upper bound value, or both, associated with the range of values for the CDD parameter.

In some examples of the method, network entities, and non-transitory computer-readable medium described herein, transmitting the first control signaling that indicates the range of values may include operations, features, means, or instructions for transmitting an indication of a mean value and of an uncertainty value, where the mean value and the uncertainty value together indicate the range of values.

Some examples of the method, network entities, and non-transitory computer-readable medium described herein may further include operations, features, means, or instructions for transmitting third control signaling that indicates a set of multiple ranges of values for the CDD parameter, where the first control signaling indicates the range of values from the set of multiple ranges of values.

In some examples of the method, network entities, and non-transitory computer-readable medium described herein, each range of values of the set of multiple ranges of values for the CDD parameter corresponds to one or more channel conditions and the one or more channel conditions include a channel delay associated with the control channel, an aggregation level associated with the control channel, a size of a control resource set of the control channel, or any combination thereof.

Some examples of the method, network entities, and non-transitory computer-readable medium described herein may further include operations, features, means, or instructions for performing a range selection procedure to obtain the set of multiple ranges of values based on the one or more channel conditions of the control channel within a time window, where the first control signaling may be transmitted based on the range selection procedure.

In some examples of the method, network entities, and non-transitory computer-readable medium described herein, the first control signaling includes a medium access control-control element (MAC-CE), a radio resource control (RRC) message, a downlink control information (DCI) message, or a combination thereof.

In some examples of the method, network entities, and non-transitory computer-readable medium described herein, the range of values for the CDD parameter corresponds to one or more control resource sets, one or more search space sets, one or more search space set groups, one or more aggregation levels, or any combination thereof, associated with the control channel.

In some examples of the method, network entities, and non-transitory computer-readable medium described herein, the range of values for the CDD parameter may be based on a channel delay characteristic associated with the control channel, a code rate associated with the control channel, one or more wireless communication resources allocated for the control channel, or any combination thereof.

In some examples of the method, network entities, and non-transitory computer-readable medium described herein, transmitting the second control signaling via the control channel based on the applied cyclic delay may include operations, features, means, or instructions for transmitting the second control signaling via one or more resource elements of the control channel, where each resource element of the control channel may be associated with a respective phase shift based on the value of the CDD parameter.

A method for wireless communications by a UE is described. The method may include receiving first control signaling that indicates a range of values for a CDD parameter associated with a control channel between a network entity and the UE, selecting a value of the CDD parameter from the indicated range of values for the CDD parameter, and receiving second control signaling via the control channel based on the value of the CDD parameter.

A UE for wireless communications is described. The UE may include one or more memories storing processor executable code, and one or more processors coupled with the one or more memories. The one or more processors may individually or collectively be operable to execute the code to cause the UE to receive first control signaling that indicates a range of values for a CDD parameter associated with a control channel between a network entity and the UE, select a value of the CDD parameter from the indicated range of values for the CDD parameter, and receive second control signaling via the control channel based on the value of the CDD parameter.

Another UE for wireless communications is described. The UE may include means for receiving first control signaling that indicates a range of values for a CDD parameter associated with a control channel between a network entity and the UE, means for selecting a value of the CDD parameter from the indicated range of values for the CDD parameter, and means for receiving second control signaling via the control channel based on the value of the CDD parameter.

A non-transitory computer-readable medium storing code for wireless communications is described. The code may include instructions executable by one or more processors to receive first control signaling that indicates a range of values for a CDD parameter associated with a control channel between a network entity and the UE, select a value of the CDD parameter from the indicated range of values for the CDD parameter, and receive second control signaling via the control channel based on the value of the CDD parameter.

In some examples of the method, UEs, and non-transitory computer-readable medium described herein, receiving the first control signaling that indicates the range of values may include operations, features, means, or instructions for receiving an indication of a lower bound value, an upper bound value, or both, associated with the range of values for the CDD parameter.

In some examples of the method, UEs, and non-transitory computer-readable medium described herein, receiving the first control signaling that indicates the range of values may include operations, features, means, or instructions for receiving an indication of a mean value and of an uncertainty value, where the mean value and the uncertainty value together indicate the range of values.

Some examples of the method, UEs, and non-transitory computer-readable medium described herein may further include operations, features, means, or instructions for receiving third control signaling that indicates a set of multiple ranges of values for the CDD parameter, where the first control signaling indicates the range of values from the set of multiple ranges of values.

In some examples of the method, UEs, and non-transitory computer-readable medium described herein, each range of values of the set of multiple ranges of values for the CDD parameter corresponds to one or more channel conditions and the one or more channel conditions include a channel delay associated with the control channel, an aggregation level associated with the control channel, a size of a control resource set of the control channel, or any combination thereof.

In some examples of the method, UEs, and non-transitory computer-readable medium described herein, the first control signaling includes a MAC-CE, an RRC message, a DCI message, or a combination thereof.

In some examples of the method, UEs, and non-transitory computer-readable medium described herein, the range of values for the CDD parameter corresponds to one or more control resource sets, one or more search space sets, one or more search space set groups, one or more aggregation levels, or any combination thereof, associated with the control channel.

In some examples of the method, UEs, and non-transitory computer-readable medium described herein, the value of the CDD parameter may be selected from the indicated range of values for the CDD parameter based on one or more configurations, one or more measurements, or both, associated with the control channel.

In some examples of the method, UEs, and non-transitory computer-readable medium described herein, the range of values for the CDD parameter may be based on a channel delay characteristic associated with the control channel, a code rate associated with the control channel, one or more wireless communication resources allocated for the control channel, or any combination thereof.

In some examples of the method, UEs, and non-transitory computer-readable medium described herein, receiving the second control signaling based on the value of the CDD parameter may include operations, features, means, or instructions for receiving the second control signaling via one or more resource elements of the control channel, where each resource element of the control channel may be associated with a respective phase shift based on the range of values for the CDD parameter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports a control channel cyclic delay diversity (CDD) scheme in accordance with one or more aspects of the present disclosure.

FIG. 2 shows an example of a wireless communications system that supports a control channel CDD scheme in accordance with one or more aspects of the present disclosure.

FIG. 3 shows an example of a process flow that supports a control channel CDD scheme in accordance with one or more aspects of the present disclosure.

FIGS. 4 and 5 show block diagrams of devices that support control channel cyclic delay diversity scheme in accordance with one or more aspects of the present disclosure.

FIG. 6 shows a block diagram of a communications manager that supports a control channel CDD scheme in accordance with one or more aspects of the present disclosure.

FIG. 7 shows a diagram of a system including a device that supports a control channel CDD scheme in accordance with one or more aspects of the present disclosure.

FIGS. 8 and 9 show block diagrams of devices that support a control channel CDD scheme in accordance with one or more aspects of the present disclosure.

FIG. 10 shows a block diagram of a communications manager that supports a control channel CDD scheme in accordance with one or more aspects of the present disclosure.

FIG. 11 shows a diagram of a system including a device that supports a control channel CDD scheme in accordance with one or more aspects of the present disclosure.

FIGS. 12 and 13 show flowcharts illustrating methods that support a control channel CDD scheme in accordance with one or more aspects of the present disclosure.

### DETAILED DESCRIPTION

Some wireless communications systems may implement a cyclic delay diversity (CDD) scheme (e.g., a cyclic shift diversity scheme) to increase robustness and redundancy associated with signaling (e.g., control signaling) within the wireless communications system. Implementing a CDD scheme may include transmitting a signal via multiple antennas associated with multiple resource elements of a channel (e.g., a control channel), where each resource element of the channel (and thus each antenna or each instance of the signal) may be associated with (e.g., transmitted via) a different phase shift (e.g., cyclic delay, cyclic shift). For example, a transmitting device may determine a value for a CDD parameter (e.g., a CDD parameter, a CDD value, a cyclic shift parameter), and may adjust (e.g., increase, decrease) a phase shift corresponding to each resource element of the channel by the value of the CDD parameter. That is, each resource element (e.g., or group of resource elements) of the channel may be associated with a different phase shift, where each phase shift may be a multiple of the CDD value.

In some cases, a transmitting device (e.g., a network entity) may implement a transparent CDD scheme, such that a receiving device (e.g., a user equipment (UE)) may not be aware of the CDD value used by the transmitting device for the transparent CDD scheme. Transparent CDD may provide some diversity gain (e.g., increased reception quality of the signal based on the CDD) for the receiving device (e.g., especially in multi path propagation scenarios), however, large CDD values (e.g., greater that 32 degrees of phase shift) may lead to increased noise at the receiving device due to the receiving device not knowing the CDD value to use when receiving and decoding signaling. In some cases, an optimal value of the CDD parameter (e.g., the value of the CDD parameter that provides the most diversity gain for a signal with the least added noise) may depend on current channel conditions for the channel between the transmitting device and the receiving device, which may change relatively frequently. Thus, signaling one or more fixed CDD values for each new channel condition (e.g., such as in a non-transparent CDD scheme) may increase signaling overhead associated with the CDD scheme. Thus, a method of implementing a CDD scheme that provides higher diversity gain without increasing overhead (e.g., such as a semi-transparent CDD scheme) may be beneficial.

According to techniques described herein, a network entity (e.g., any network device or wireless device) may transmit first control signaling to a UE (e.g., another network device or wireless device), where the first control signaling may indicate a range of values for a CDD parameter associated with a channel (e.g., a control channel, a data or shared channel, both) between the network entity and the UE. The UE may select a CDD value from the range of values based on one or more measurements, a configuration, or both, associated with the channel. The network entity may apply a cyclic delay (e.g., a diverse cyclic delay, CDD) to the channel (e.g., to each resource element of the channel) between the network entity and the UE according to a CDD value from the range of values, and may transmit, according to the applied cyclic delay, second control signaling to the UE. In some cases, the UE may receive (e.g., decode, process) the second control signaling according to the CDD value selected by the UE. Thus, the UE may receive the benefits of larger CDD values while reducing signaling overhead by signaling the range of values.

The network entity may indicate the range of values for the CDD parameter via one or more techniques. For example, the first control signaling may indicate a lower value of the range of values, an upper value of the range of values, or any combination thereof. Additionally, or alternatively, the network entity may transmit control signaling (e.g., third control signaling) that may indicate multiple ranges of values for the CDD parameter (e.g., potential CDD value ranges), and the first control signaling may indicates the range of values from the multiple ranges of values. Additionally, or alternatively, the first control signaling may indicate a mean value (e.g., a middle value, an average value, an expected value) of the range of values, an uncertainty value (e.g., a difference between an endpoints of the range of values and the mean value), or both, where the mean value and the uncertainty value may indicate the range of values. In some examples, the network entity may configure the range of values for the CDD parameter for a set of one or more control channel resources, where the set of one or more control channel resources may include one or more control resource sets, one or more search space sets, one or more search space set groups (SSSGs), one or more aggregation levels associated with the channel, or any combination thereof.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to control channel cyclic delay diversity scheme.

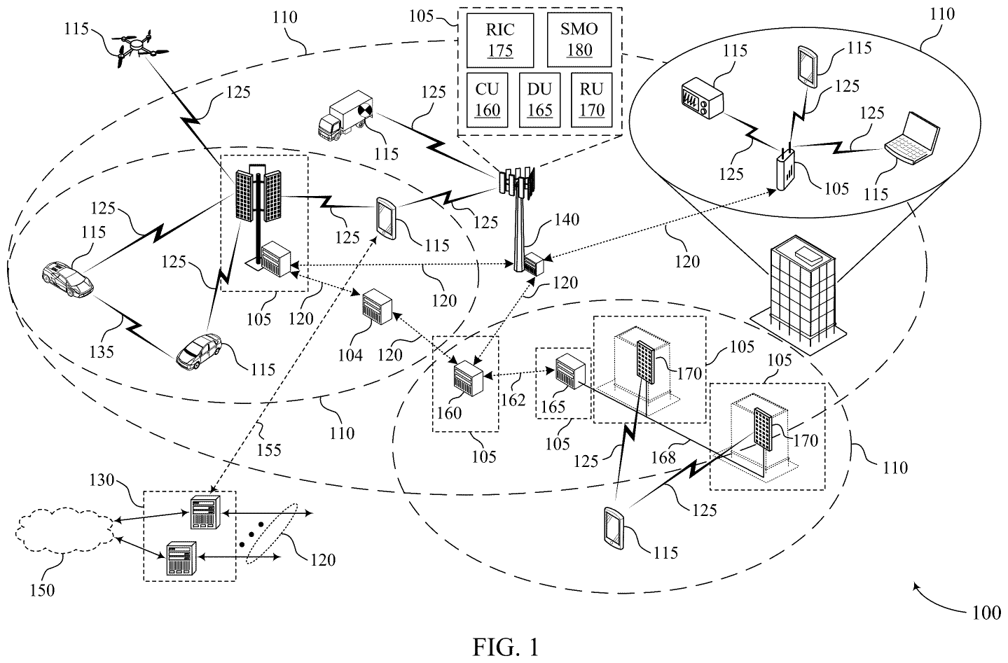

FIG. 1 shows an example of a wireless communications system 100 that supports a control channel CDD scheme in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a network entity 105 (e.g., any network device or wireless device) may transmit first control signaling to a UE 115 (e.g., another network device or wireless device), where the first control signaling may indicate a range of values for a CDD parameter associated with a channel (e.g., a control channel, a data or shared channel, both) between the network entity 105 and the UE 115. The UE 115 may select a CDD value from the range of values based on one or more measurements, a configuration, or both, associated with the channel. The network entity 105 may apply a cyclic delay (e.g., a diverse cyclic delay, CDD) to the channel (e.g., to each resource element of the channel) between the network entity 105 and the UE 115 according to a CDD value from the range of values, and may transmit, according to the applied cyclic delay, second control signaling to the UE 115. In some cases, the UE 115 may receive (e.g., decode, process) the second control signaling according to the CDD value selected by the UE 115. Thus, the UE 115 may receive the benefits of larger CDD values while maintaining low signaling overhead by signaling the range of values.

The network entity 105 may indicate the range of values for the CDD parameter via one or more techniques. For example, the first control signaling may indicate a lower value of the range of values, an upper value of the range of values, or any combination thereof. Additionally, or alternatively, the network entity 105 may transmit control signaling (e.g., third control signaling) that may indicate multiple ranges of values for the CDD parameter (e.g., potential CDD value ranges), and the first control signaling may indicates the range of values from the multiple ranges of values. Additionally, or alternatively, the first control signaling may indicate a mean value (e.g., a middle value, an average value, an expected value) of the range of values, an uncertainty value (e.g., a difference between an endpoints of the range of values and the mean value), or both, where the mean value and the uncertainty value may indicate the range of values. In some examples, the network entity 105 may configure the range of values for the CDD parameter for a set of one or more control channel resources, where the set of one or more control channel resources may include one or more control resource sets, one or more search space sets, one or more SSSGs, one or more aggregation levels associated with the channel, or any combination thereof.

Accordingly, signaling transmitted via the channel between the UE 115 and the network entity 105 may experience a relatively high diversity gain and utilize relatively low signaling overhead based on indicating the range of CDD values. For example, as the channel conditions change over time, the network entity 105 may use a different CDD value for the channel that is within the range of values, or may signal a new range of values to the UE 115. Thus, the UE 115 and the network entity 105 may be coordinated enough to use larger and more advantageous CDD values without the overhead associated with transparent CDD schemes.

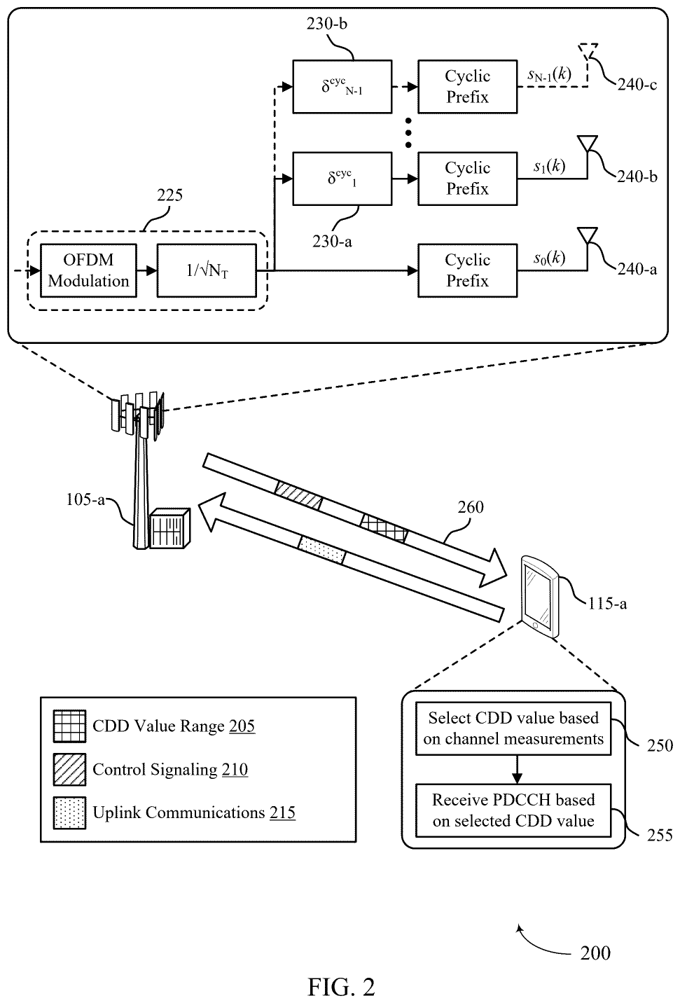

FIG. 2 shows an example of a wireless communications system 200 that supports a control channel CDD scheme in accordance with one or more aspects of the present disclosure. In some cases, aspects of the wireless communications system 200 may implement or be implemented by aspects of FIG. 1. For example, the wireless communications system 200 may include a network entity 105-a and a UE 115-a, which may be examples of the network entities 105 and the UEs 115, respectively, as described herein with respect to FIG. 1. The wireless communications system 200 may also include a CDD value range 205 (e.g., an example of the range of values for the CDD parameter described with respect to FIG. 1), control signaling 210 (e.g., an example of signaling described with respect to FIG. 1), and a control channel 260 (e.g., an example of the channel described with respect to FIG. 1, a physical downlink control channel (PDCCH), a physical uplink control channel (PUCCH)). Additionally, operations performed by the network entity 105-a, the UE 115-a, or both, may be performed by one or more other wireless or network devices (e.g., two UEs 115, two network entities 105, or any combination thereof). In some aspects, the network entity 105-a may indicate a CDD value range 205 to the UE 115-a, and the network entity 105-a may transmit control signaling 210 to the UE 115-a based on the indicated CDD value range 205. The UE 115-a may also select a CDD value from the CDD value range 205 (e.g., a cyclic shift range, a range of values for a cyclic shift parameter) and may receive the control signaling 210 according to the selected CDD value.

In some cases, the network entity 105-a may implement a CDD scheme for the control channel 260. Implementing the CDD scheme may include transmitting the control signaling 210 via multiple antennas 240 (e.g., or multiple groups of antennas) corresponding to respective resource elements of the control channel 260. For example, at 225, the network entity 105-a may perform one or more operations on control information to form a control signal (e.g., represented as s (k)), where the one or more operations may include OFDM modulation and application of a modifier

$$( e . g . , \frac{1}{\sqrt{{N}_{T}}} ,$$

where NT may be a quantity of antennas 240 or groups of the antennas 240 used to transmit the control signaling 210). The network entity 105-a may send the signal s (k) to one or more transmission circuits, which may add a cyclic delay 8 (e.g., a cyclic shift 8) based on a value of the CDD parameter (e.g., selected by the network entity 105-a), and may add a cyclic prefix to the signal before transmitting the signal with a respective cyclic delay and a cyclic prefix via a respective antenna 240 (e.g., or group of antennas). In some cases, the cyclic delay 8 may be shorter than the cyclic prefix (e.g., a small delay) or larger than the cyclic prefix (e.g., a large delay).

As an example, according to the CDD scheme, the network entity 105-a may apply no cyclic delay to the signal transmitted by an antenna 240-a, may increase the cyclic delay δ (e.g., at 230-a) by the selected CDD to be a cyclic delay of

$${δ}_{1}^{cyc}$$

for an antenna 240-b, and so forth, until adding a cyclic delay of

$${δ}_{{N}_{T} - 1}^{cyc}$$

(e.g., at 230-b) for an antenna 240-c. In some cases, the network entity 105-a (e.g., or another transmitting device) may include any quantity N of antennas 240. In other words, the network entity 105-a may modify and send the signal s (k) from each antenna 240 (e.g., via respective resource elements) as s₀(k), s₁(k), and so forth until s_{N}_{_{T}}₋₁(k), where each signal sᵢ(k) is associated with an increasing respective cyclic delay δ (e.g., a phase shift δ) that is a multiple of the value of the CDD parameter.

In some examples, CDD schemes may be large delay schemes (LD-CDD schemes) or small delay schemes (SD-CDD schemes). For example, LD-CDD schemes may include CDD values that are larger than the cyclic prefix, and SD-CDD schemes may include CDD values that are small compared to the cyclic prefix. Thus, some SD-CDD schemes may be implemented in a transparent manner in some wireless communications systems, as the receiver may receive the signaling without having an indication of the value of the CDD parameter. However, some LD-CDD schemes may be implemented in a non-transparent manner based on the large CDD values causing poor reception quality if the receiving device (e.g., the UE 115-a) is not aware of the used CDD value.

In some cases, control channels (e.g., such as the control channel 260) may benefit from the implementation of CDD schemes more so than other channels. For example, some control channels (e.g., PDCCHs, PUCCHs) may be associated with relatively low aggregation levels (e.g., aggregation level 1, aggregation level 2, as described herein with respect to FIG. 1, low when compared to the aggregation levels of other channels). As lower aggregation levels may use fewer carriers, transmission diversity (e.g., TxD) of control channels may be relatively low compared to other channels. Thus, CDD schemes may increase a transmission diversity and provide enhanced control channel reliability to the control channel 260 that may not be provided by the aggregation level of the control channel 260.

Some CDD schemes (e.g., physical resource block group (PRG)-level precoder cycling or SD-CDD) may be transparent to the UE 115-a. That is, the UE 115-a may not be aware of the network entity 105-a applying the CDD scheme to the control channel 260 (e.g., the UE 115-a may not be aware of the value of the CDD parameter applied to the control channel 260), and the UE 115-a may function as if no CDD were applied to the control channel 260. However, transparent CDD schemes may rely on using small CDD values (e.g., very small CDD values, such as less than 32 degrees of phase shift) to avoid performance degradation due to CDD value mismatch between transmitter and receiver, which may limit potential transmission diversity gain.

In non-transparent CDD schemes, the UE 115-a may be aware of the CDD value applied to the control channel 260, and thus the network entity 105-a may utilize a relatively larger value of the CDD parameter (e.g., above 32 degrees of phase shift within a SD-CDD scheme). However, the network entity 105-a may communicate the CDD value to the UE 115-a, and thus non-transparent CDD schemes may also utilize relatively large amounts of overhead to coordinate the CDD parameter value between the network entity 105-a and the UE 115-a. For example, frequent changes in channel conditions may cause the CDD value to change frequently, increasing signaling between the network entity 105-a and the UE 115-a. Thus, to increase potential diversity gain while maintaining low signaling overhead, the wireless communications system 200 may implement a semi-transparent CDD scheme (e.g., a semi-transparent SD-CDD), which may utilize larger CDD values than a transparent CDD scheme and be associated with a reduced overhead (e.g., compared to a non-transparent CDD scheme) based on utilizing a CDD value range 205.

For example, in such a semi-transparent CDD scheme, the network entity 105-a (e.g., a transmitting device) may indicate a CDD value range 205 (e.g., a range of values for the CDD parameter, for example, between 64 degrees to 128 degrees of phase shift for one or more channel conditions) to the UE 115-a (e.g., a receiving device). The network entity 105-a may utilize CDD values for the control channel 260 within the coordinated CDD value range 205 (e.g., for a period of time, until channel conditions of the control channel 260 change more than a threshold amount). The UE 115-a may receive (e.g., decode, process) signaling from the network entity 105-a via the control channel 260 (e.g., PDCCH signaling) according to the CDD value range 205, which may maintain a low performance degradation due to CDD mismatch between the network entity 105-a and the UE 115-a, and may allow for larger diversity gains on the control channel 260 due to the relatively larger values within the CDD value range 205.

In some examples, the network entity 105-a may indicate the CDD value range 205 to the UE 115-a via one or more of multiple techniques. In a first example, the network entity 105-a may indicate a lower bound value and an upper bound value (e.g., (x, y), where x is the lower bound value and y is the upper bound value) to indicate the CDD value range 205. In another example, the network entity 105-a may indicate a lower bound value for the CDD value range without an upper bound value or an upper bound value without a lower bound value, which may indicate that the CDD value range may include all CDD values above the lower bound value or below the upper bound value, respectively. In yet another example, the network entity 105-a may indicate a mean value (e.g., a CDD value in the middle of the CDD value range 205, and expected CDD value, a middle CDD value), an uncertainty value (e.g., an expected CDD value uncertainty), or both, which may indicate the CDD value range 205 to the UE 115-a. For example, the uncertainty value may be a width of the CDD value range, a distance from the mean value to the lower bound, the upper bound, or both (e.g., half of the width of the CDD value range), or any combination thereof. Alternatively, the UE 115-a may be configured with a fixed uncertainty value, or the network entity 105-a may not indicate the uncertainty value to the UE 115-a (e.g., only the mean value). Additionally, or alternatively, the network entity 105-a may dynamically adjust, update or change one or more aspects of the CDD value range 205 (e.g., according to any of the examples herein) via control signaling (e.g., MAC-CE, DCI message, RRC signaling).

In some cases, the network entity 105-a may configure (e.g., or reconfigure) the UE 115-a with multiple CDD value ranges 205 (e.g., via RRC signaling, via other control signaling), and may dynamically indicate (e.g., via a DCI message, via a MAC-CE) one of the CDD value ranges 205 to the UE 115-a to utilize for a period of time (e.g., periodically, until the network entity 105-a indicates otherwise or aperiodically). For example, the network entity 105-a may indicate each of the multiple CDD value ranges 205 to the UE 115-a according to one or more of the examples described herein (e.g., and as described with respect to Table 1). To indicate the CDD value range 205 for the UE 115-a to utilize, each CDD value range 205 of the multiple may be associated with an index, and the network entity 105-a may indicate the index associated with the CDD value range 205 to the UE 115-a. Additionally, or alternatively, the network entity 105-a may indicate the CDD value range 205 of the multiple by transmitting an indication of a lower or upper bound of the CDD value range 205, a mean value of the one CDD value range 205, or another parameter associated with or indicative of the CDD value range 205.

In some cases, the CDD value range 205 (e.g., or each CDD value range 205 of the multiple) may be for (e.g., associated with, correspond to) a set of control channel resources of the control channel 260. For example, the network entity 105-a may configure the UE 115-a with (e.g., indicate to the UE 115-a) one CDD value range 205 for one set of control resources of the control channel 260, or may configure the UE 115-a with (e.g., indicate to the UE 115-a) multiple CDD value ranges 205 for multiple sets of control resources at a time. In some cases, a set of control resources may include one or more CORESETs, one or more search space sets, one or more SSSGs, or any combination thereof. Additionally, or alternatively, the CDD value range 205 may be associated with an aggregation level of the control channel 260. Thus, if the UE 115-a is configured with a CDD value range 205 for a set of control channel resources or an aggregation level, the UE 115-a may utilize the CDD value range 205 to receive signaling within the set of control channel resources and at the aggregation level, and may not use the CDD value range 205 to receive signaling within another set of control channel resources or at another aggregation level.

In some cases, an optimal CDD value for use on the control channel 260 (e.g., the CDD value that provides the most diversity gain for a signal with the least added noise) may depend on one or more channel conditions of the control channel 260 (e.g., one or more values of channel parameters for the control channel 260 at an instance or within a time window). For example, the one or more channel conditions may include channel delay characteristics, a code rate, a resource allocation, an aggregation level, a CORESET size, or other channel conditions. In some cases, the network entity 105-a may periodically transmit the CDD value range 205 or the multiple CDD value ranges 205 to the UE 115-a, where each CDD value range 205 may be associated with a respective set of channel conditions (e.g., a respective set of values for channel parameters).

In some examples, the network entity may perform a range selection procedure (e.g., one or more advanced algorithm) to select (e.g., determine) the CDD value range for each set of channel conditions within a time window. For example, the network entity 105-a may perform one or more measurements of the control channel 260 (e.g., or receive one or more measurement values from the UE 115-a for the control channel 260) associated with a time window, and may determine one or more CDD value ranges 205 to configure (e.g., or indicate) to the UE 115-a based on the one or more measurements. Each CDD value range 205 may be associated with a set of channel conditions. Such CDD value ranges 205 may be organized into a table which is indicated to the UE 115-a, an example of which table may be found in Table 1.

TABLE 1

| | Channel Delay (root mean square (RMS)): | | |
|---|---|---|---|
| | 30 | 100 | 300 |
| Aggregation Level 1 | CDD Value | CDD Value | CDD Value |
| | Range 1 | Range 2 | Range 3 |
| Aggregation Level 2 | CDD Value | CDD Value | CDD Value |
| | Range 4 | Range 5 | Range 6 |
| . . . | | | |
| N symbols per CORESET | CDD Value | CDD Value | CDD Value |
| | Range 7 | Range 8 | Range 9 |
| M symbols per CORESET | CDD Value | CDD Value | CDD Value |
| | Range 10 | Range 11 | Range 12 |
| . . . | | | |

The channel conditions (e.g., the channel parameters and the associated values) included in Table 1 are merely exemplary and in no way limit the techniques described herein. In Table 1, each CDD value range 205 may be a same or different CDD value range 205, and each CDD value range 205 may be indicated according to one or more of the examples described herein. In some cases, the values of the channel delay listed in Table 1 may be in units of milliseconds, microseconds, or any other unit of time.

In some examples, the UE 115-a may select a CDD value from the indicated CDD value range 205 to use for receiving signaling via the control channel 260. For example, at 250, the UE 115-a may select a CDD value based on one or more configuration for the control channel 260 (e.g., configured aggregation level, a quantity of symbols per CORESET), current channel measurements (e.g., real time channel measurements) of the control channel 260, or both. In some cases, selecting the CDD value may include select a CDD value range 205 from the Table 1 (e.g., or another indication of the multiple CDD value ranges 205) based on the indicated CDD value range, the one or more configurations, the one or more current channel measurements, or any combination thereof.

After selecting a CDD value range 205, a CDD value, or both, the UE 115-a (e.g., at 255) may receive the control signaling 210 (e.g., a PDCCH transmission) according to the selected CDD value range 205, the selected CDD value, or both. For example, the UE 115-a may receive the control signaling 210 as multiple signals (e.g., as in a MIMO system, via various delay paths) with various cyclic delays (e.g., phase shifts). Based on the selected CDD value range 205, the selected CDD value, or both, the UE 115-a may process (e.g., decode) the multiple signals to obtain control information associated with the control signaling 210. For example, the UE 115-a may apply the selected CDD value to align the phase of the multiple signals and obtain control information from the control signaling 210. Thus, the UE 115-a may receive the control signaling 210 using a CDD value that is greater than may be used in a transparent CDD scheme (e.g., increasing diversity gain associated with the control signaling 210), but with less overhead than may be associated with a non-transparent CDD scheme.

In some examples, the UE 115-a may also transmit uplink communications to the network entity 105-a based on the semi-transparent CDD scheme. For example, the UE 115-a may apply the selected CDD value to an uplink channel between the UE and the network entity 105-a, and may transmit signaling to the network entity 105-a accordingly. The network entity 105-a may determine a value for the CDD parameter from the CDD value range 205 configured to the UE 115-a, and may receive the uplink communications 215 based on the determined value (e.g., as described herein).

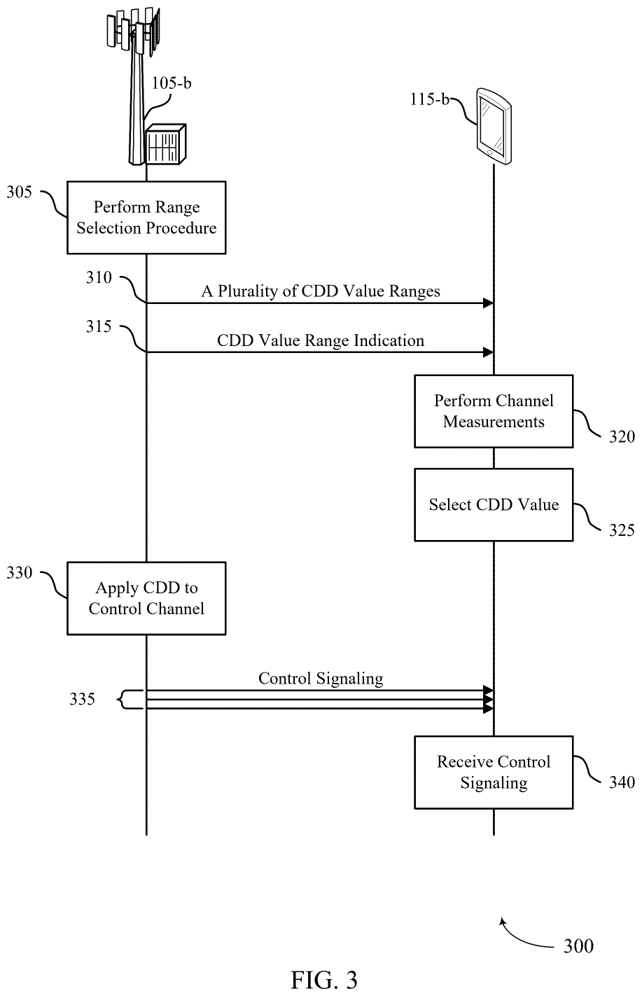

FIG. 3 shows an example of a process flow 300 that supports a control channel CDD scheme in accordance with one or more aspects of the present disclosure. In some cases, aspects of the process flow 300 may implement or be implemented by aspects of FIGS. 1 and 2. For example, the process flow 300 may include a UE 115-b and an network entity 105-b, which may be examples of the UEs 115 and the network entities 105 as described herein with respect to FIGS. 1 and 2. In some aspects, the network entity 105-b may indicate a CDD value range (e.g., a cyclic shift value range) to the UE 115-b, the UE 115-b may select a CDD value for receiving control signaling from the network entity 105-b, the network entity 105-b may transmit control signaling according to the CDD value range, and the UE 115-b may receive the control signaling according to the selected CDD value (e.g., a selected cyclic shift value).

In the following description of process flow 300, the operations may be performed in a different order than the order shown, or other operations may be added or removed from the process flow 300. For example, some operations may also be left out of process flow 300, may be performed in different orders or at different times, or other operations may be added to process flow 300. Although the UE 115-b and the network entity 105-b are shown performing the operations of process flow 300, some aspects of some operations may also be performed by one or more other wireless devices or network devices.

At 305, the network entity 105-b may perform a range selection procedure to obtain multiple ranges of values for a CDD parameter (e.g., a CDD value), where the CDD parameter may be associated with a control channel between the network entity 105-b and the UE 115-b. In some examples, the range selection procedure may be based on the one or more channel conditions (e.g., one or more values of one or more channel parameters) of the control channel within a time window. For example, the network entity 105-b may measure (e.g., or receive an indication of measurements of) one or more channel conditions for the control channel between the network entity 105-b and the UE 115-b over a time window, and may select (e.g., determine) one or more ranges of values for the CDD parameter based on the measurements.

In one example, the network entity 105-b may select each range of values of the multiple ranges of values for the CDD parameter to correspond to the one or more channel conditions (e.g., to a set of values for the one or more channel parameters, as described herein with respect to Table 1). For example, each range of CDD values may provide improved communication (e.g., higher gain values) for the corresponding one or more channel conditions. The one or more channel conditions (e.g., channel parameters) may include a channel delay associated with the control channel, an aggregation level associated with the control channel, a size of a control resource set of the control channel, or any combination thereof. In some cases, the network entity 105-b may also select a range of values of the more one or more ranges of values to indicate to the UE 115-b (e.g., at 315) based on the one or more channel conditions, or may select only a single range of values using the range selection procedure.

At 310, the network entity 105-b may transmit (e.g., to the UE 115-b) control signaling (e.g., third control signaling) that indicates the multiple ranges of values for the CDD parameter in response to performing the range selection procedure (e.g., as part of the range selection procedure). In some examples, the network entity 105-b may also indicate the one or more channel conditions (e.g., or value of the one or more channel parameters) that correspond to each range of values to the UE 115-b (e.g., such as in Table 1).

At 315, the network entity 105-b may transmit control signaling (e.g., first control signaling) to the UE 115-b that indicates a range of values for the CDD parameter (e.g., a CDD value range indication). In some examples, the network entity 105-b may transmit the first control signaling based on the range selection procedure. For example, the first control signaling may indicate the range of values from the multiple ranges of values, or may indicate the range of values separate from or without indicating the multiple ranges of values. Additionally, or alternatively, the first control signaling may include an indication of a lower bound value, an upper bound value, or both, associated with the range of values for the CDD parameter. Additionally, or alternatively, the first control signaling may include an indication of a mean value (e.g., a middle value of the range of values), an uncertainty value (e.g., half of the difference between a largest value and a smallest value of the range of values), or both, where the mean value and the uncertainty value together may indicate the range of values. In some examples, the first control signaling may include a MAC-CE, an RRC message, a DCI message, or a combination thereof.

In some cases, the indicated range of values for the CDD parameter may correspond to (e.g., be applicable to, be used for) a subset of control resources of the control channel between the network entity 105-b and the UE 115-b. For example, the range of values may correspond to one or more control resource sets, one or more search space sets, one or more search space set groups, one or more aggregation levels, or any combination thereof, associated with the control channel. Additionally, or alternatively, the network entity 105-b may determine the range of values for the CDD parameter based on a channel delay characteristic associated with the control channel, a code rate associated with the control channel, one or more wireless communication resources allocated for the control channel, or any combination thereof.

At 320, the UE 115-b may perform one or more measurements (e.g., channel measurements) associated with the control channel between the network entity 105-b and the UE 115-b. For example, the UE 115-b may measure any one of the channel conditions described herein. In some examples, the UE 115-b may perform the one or more measurements in response to receiving the indication of the range of values for the CDD parameter (e.g., at 315).

At 325, the UE 115-b may select a value of the CDD parameter (e.g., a CDD value) from the indicated range of values. For example, the UE 115-b may select the value of the CDD parameter based on one or more configurations (e.g., PDCCH configurations, a CDD parameter configuration, other configurations), the one or more measurements (e.g., of 320), or both, associated with the control channel.

At 330, the network entity 105-b may apply a cyclic delay to the control channel using a value of the CDD parameter, where the value may be within the range of values for the CDD parameter. For example, the network entity 105-b may select the value of the CDD parameter based on one or more channel conditions determined at the network entity 105-b (e.g., instantaneous channel conditions, channel conditions over a second time window). In some aspects, applying the cyclic delay to the control channel may be further described herein with respect to FIG. 2.

At 335, the network entity 105-b may transmit, via the control channel and based on the applied cyclic delay, control signaling (e.g., second control signaling) to the UE 115-b. In some examples, the network entity 105-b may transmit the second control signaling via one or more resource elements of the control channel, where each resource element of the control channel may be associated with a respective phase shift (e.g., phase delay) based on the applying the cyclic delay to the control channel using value of the CDD parameter.

At 340, the UE 115-b may receive the second control signaling via the control channel based on the selected value of the CDD parameter. For example, the second control signaling may convey information via multiple phase shifted signals (e.g., based on applying the cyclic delay), and the UE 115-b may use the selected value of the CDD parameter to combine the multiple phase shifted signals and extract control information from the multiple phase shifted signals (e.g., as further described herein with respect to FIG. 2).

Thus, according to the techniques described herein, a wireless communications system may implement a semi-transparent CDD scheme for a control channel. Such techniques may increase a robustness in the control signaling in the wireless communications system based on the diversity provided by the CDD scheme. Additionally, due to the range of values provided for the CDD parameter, the CDD scheme may be capable of increasing signaling robustness while adapting to rapidly shifting channel conditions for the control channel.

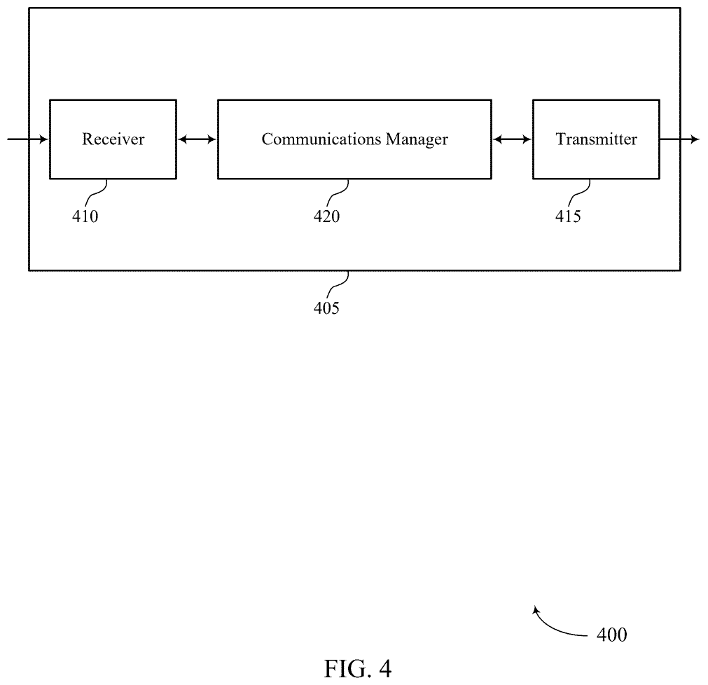

FIG. 4 shows a block diagram 400 of a device 405 that supports a control channel CDD scheme in accordance with one or more aspects of the present disclosure. The device 405 may be an example of aspects of a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of control channel cyclic delay diversity scheme as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting first control signaling that indicates a range of values for a CDD parameter associated with a control channel between the network entity and a UE. The communications manager 420 is capable of, configured to, or operable to support a means for applying a cyclic delay to the control channel using a value of the CDD parameter, where the value is within the range of values for the CDD parameter. The communications manager 420 is capable of, configured to, or operable to support a means for transmitting, via the control channel and based on the applied cyclic delay, second control signaling.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources. For example, a network entity 105 implementing the semi-transparent CDD scheme described herein may increase a diversity gain associated with control signaling while maintaining a low signaling overhead for the semi-transparent CDD scheme, which may reduce signaling and power usage at the network entity 105.

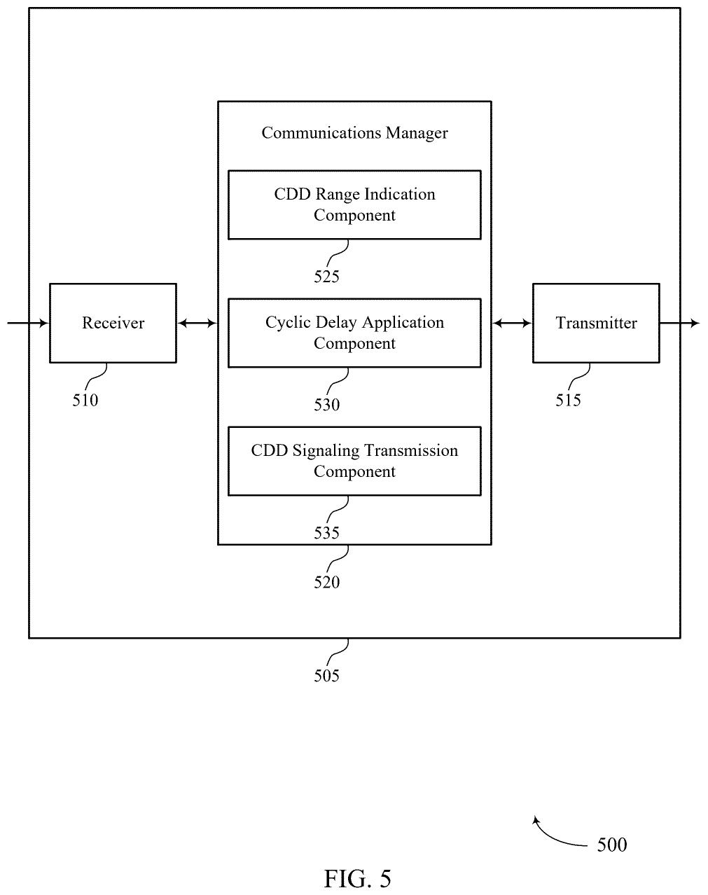

FIG. 5 shows a block diagram 500 of a device 505 that supports a control channel CDD scheme in accordance with one or more aspects of the present disclosure. The device 505 may be an example of aspects of a device 405 or a network entity 105 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of control channel cyclic delay diversity scheme as described herein. For example, the communications manager 520 may include a CDD range indication component 525, a cyclic delay application component 530, a CDD signaling transmission component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The CDD range indication component 525 is capable of, configured to, or operable to support a means for transmitting first control signaling that indicates a range of values for a CDD parameter associated with a control channel between the network entity and a UE. The cyclic delay application component 530 is capable of, configured to, or operable to support a means for applying a cyclic delay to the control channel using a value of the CDD parameter, where the value is within the range of values for the CDD parameter. The CDD signaling transmission component 535 is capable of, configured to, or operable to support a means for transmitting, via the control channel and based on the applied cyclic delay, second control signaling.

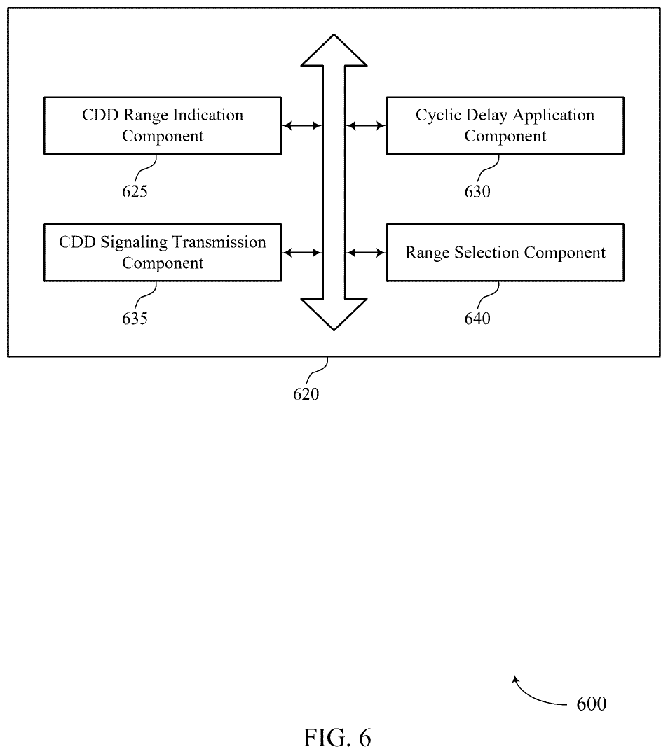

FIG. 6 shows a block diagram 600 of a communications manager 620 that supports a control channel CDD scheme in accordance with one or more aspects of the present disclosure. The communications manager 620 may be an example of aspects of a communications manager 420, a communications manager 520, or both, as described herein. The communications manager 620, or various components thereof, may be an example of means for performing various aspects of control channel cyclic delay diversity scheme as described herein. For example, the communications manager 620 may include a CDD range indication component 625, a cyclic delay application component 630, a CDD signaling transmission component 635, a range selection component 640, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communications in accordance with examples as disclosed herein. The CDD range indication component 625 is capable of, configured to, or operable to support a means for transmitting first control signaling that indicates a range of values for a CDD parameter associated with a control channel between the network entity and a UE. The cyclic delay application component 630 is capable of, configured to, or operable to support a means for applying a cyclic delay to the control channel using a value of the CDD parameter, where the value is within the range of values for the CDD parameter. The CDD signaling transmission component 635 is capable of, configured to, or operable to support a means for transmitting, via the control channel and based on the applied cyclic delay, second control signaling.

In some examples, to support transmitting the first control signaling that indicates the range of values, the CDD range indication component 625 is capable of, configured to, or operable to support a means for transmitting an indication of a lower bound value, an upper bound value, or both, associated with the range of values for the CDD parameter.

In some examples, to support transmitting the first control signaling that indicates the range of values, the CDD range indication component 625 is capable of, configured to, or operable to support a means for transmitting an indication of a mean value and of an uncertainty value, where the mean value and the uncertainty value together indicate the range of values.

In some examples, the CDD range indication component 625 is capable of, configured to, or operable to support a means for transmitting third control signaling that indicates a set of multiple ranges of values for the CDD parameter, where the first control signaling indicates the range of values from the set of multiple ranges of values.

In some examples, each range of values of the set of multiple ranges of values for the CDD parameter corresponds to one or more channel conditions. In some examples, the one or more channel conditions include a channel delay associated with the control channel, an aggregation level associated with the control channel, a size of a control resource set of the control channel, or any combination thereof.

In some examples, the range selection component 640 is capable of, configured to, or operable to support a means for performing a range selection procedure to obtain the set of multiple ranges of values based on the one or more channel conditions of the control channel within a time window, where the first control signaling is transmitted based on the range selection procedure.

In some examples, the first control signaling includes a medium access control-control element (MAC-CE), an RRC message, a DCI message, or a combination thereof.

In some examples, the range of values for the CDD parameter corresponds to one or more control resource sets, one or more search space sets, one or more search space set groups, one or more aggregation levels, or any combination thereof, associated with the control channel.

In some examples, the range of values for the CDD parameter is based on a channel delay characteristic associated with the control channel, a code rate associated with the control channel, one or more wireless communication resources allocated for the control channel, or any combination thereof.

In some examples, to support transmitting the second control signaling via the control channel based on the applied cyclic delay, the CDD signaling transmission component 635 is capable of, configured to, or operable to support a means for transmitting the second control signaling via one or more resource elements of the control channel, where each resource element of the control channel is associated with a respective phase shift based on the value of the CDD parameter.

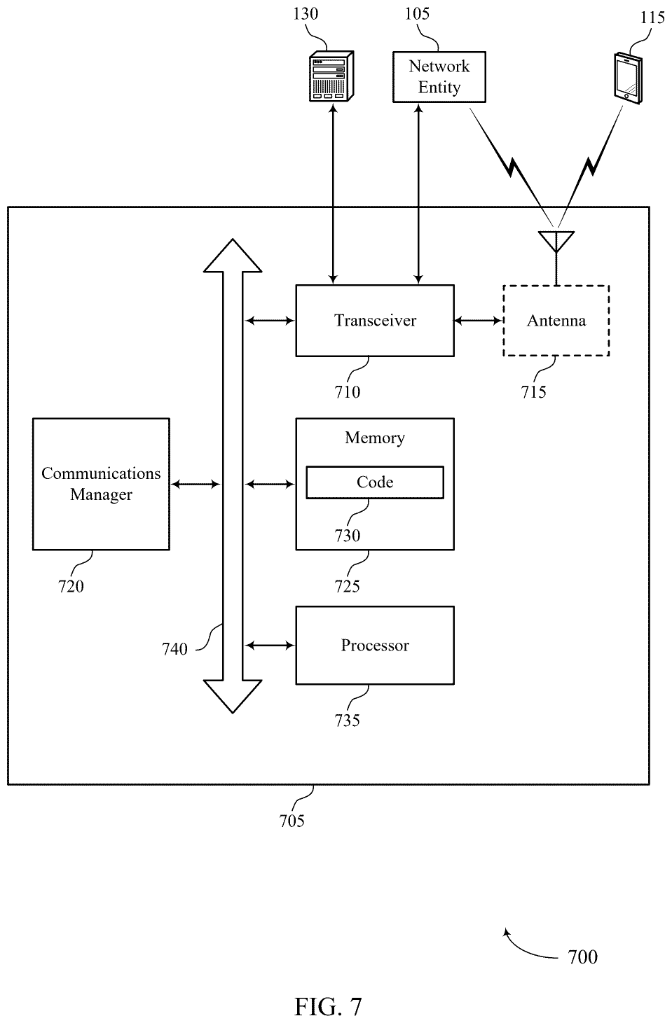

FIG. 7 shows a diagram of a system 700 including a device 705 that supports a control channel CDD scheme in accordance with one or more aspects of the present disclosure. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting control channel cyclic delay diversity scheme). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communications in accordance with examples as disclosed herein. For example, the communications manager 720 is capable of, configured to, or operable to support a means for transmitting first control signaling that indicates a range of values for a CDD parameter associated with a control channel between the network entity and a UE. The communications manager 720 is capable of, configured to, or operable to support a means for applying a cyclic delay to the control channel using a value of the CDD parameter, where the value is within the range of values for the CDD parameter. The communications manager 720 is capable of, configured to, or operable to support a means for transmitting, via the control channel and based on the applied cyclic delay, second control signaling.

By including or configuring the communications manager 720 in accordance with examples as described herein, the device 705 may support techniques for reduced power consumption and more efficient utilization of communication resources. For example, a network entity 105 implementing the semi-transparent CDD scheme described herein may increase a diversity gain associated with control signaling while maintaining a low signaling overhead for the semi-transparent CDD scheme, which may reduce signaling and power usage at the network entity 105.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of control channel cyclic delay diversity scheme as described herein, or the at least one processor 735 and the at least one memory 725 may be otherwise configured to, individually or collectively, perform or support such operations.

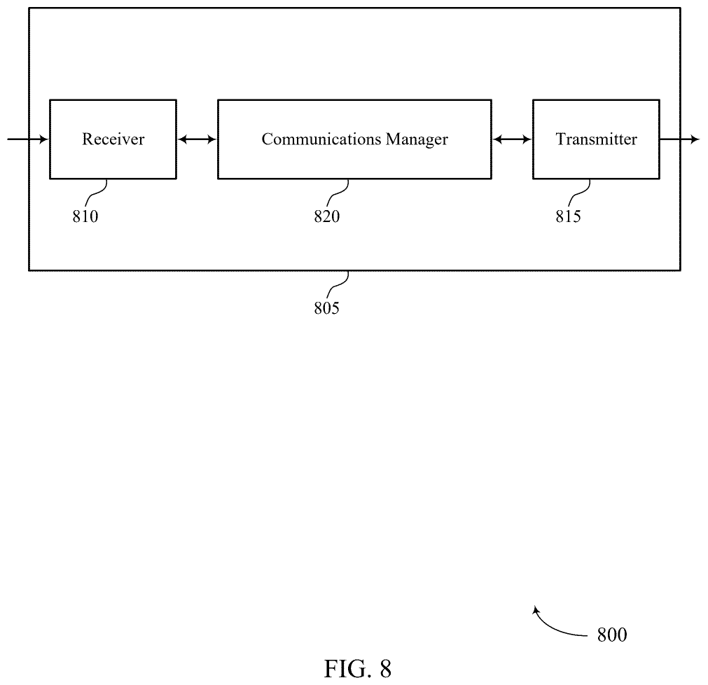

FIG. 8 shows a block diagram 800 of a device 805 that supports a control channel CDD scheme in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to control channel cyclic delay diversity scheme). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to control channel cyclic delay diversity scheme). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of control channel cyclic delay diversity scheme as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first control signaling that indicates a range of values for a CDD parameter associated with a control channel between a network entity and the UE. The communications manager 820 is capable of, configured to, or operable to support a means for selecting a value of the CDD parameter from the indicated range of values for the CDD parameter. The communications manager 820 is capable of, configured to, or operable to support a means for receiving second control signaling via the control channel based on the value of the CDD parameter.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources. For example, a UE 115 implementing the semi-transparent CDD scheme described herein may experience increased diversity gain associated with control signaling while maintaining a low signaling overhead for the semi-transparent CDD scheme, which may reduce signaling and power usage at the UE 115.

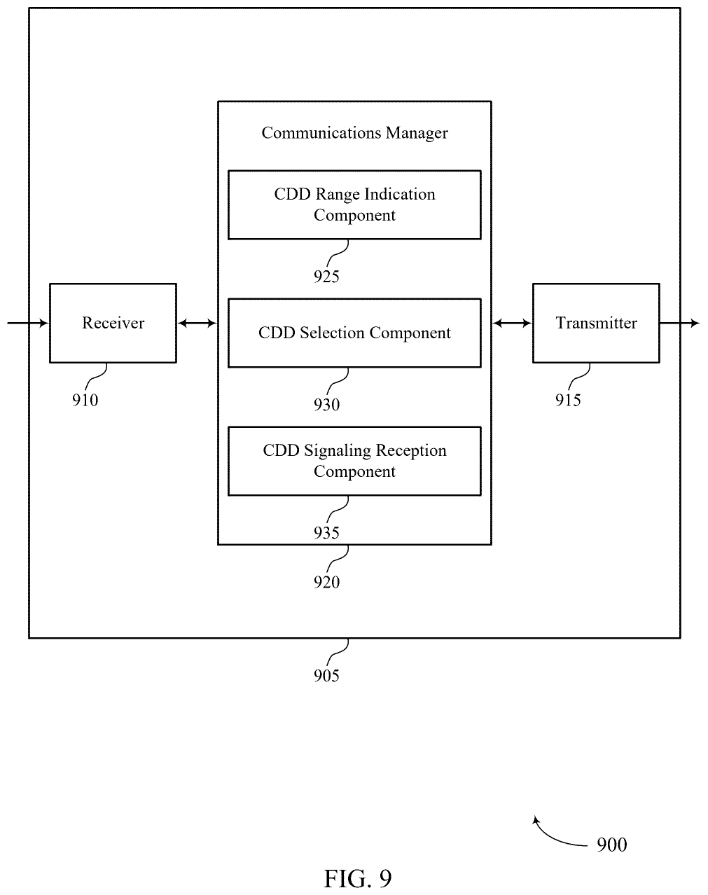

FIG. 9 shows a block diagram 900 of a device 905 that supports a control channel CDD scheme in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to control channel cyclic delay diversity scheme). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to control channel cyclic delay diversity scheme). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of control channel cyclic delay diversity scheme as described herein. For example, the communications manager 920 may include a CDD range indication component 925, a CDD selection component 930, a CDD signaling reception component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The CDD range indication component 925 is capable of, configured to, or operable to support a means for receiving first control signaling that indicates a range of values for a CDD parameter associated with a control channel between a network entity and the UE. The CDD selection component 930 is capable of, configured to, or operable to support a means for selecting a value of the CDD parameter from the indicated range of values for the CDD parameter. The CDD signaling reception component 935 is capable of, configured to, or operable to support a means for receiving second control signaling via the control channel based on the value of the CDD parameter.

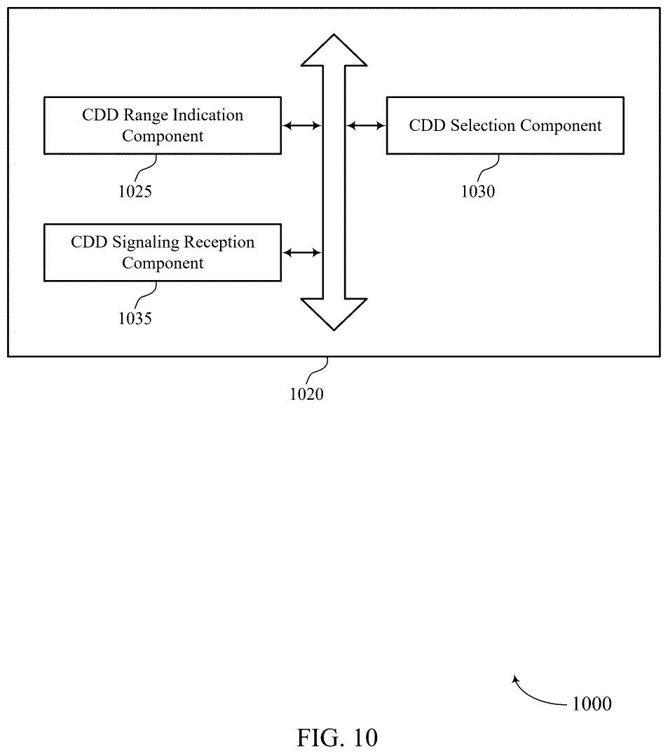

FIG. 10 shows a block diagram 1000 of a communications manager 1020 that supports a control channel CDD scheme in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of control channel cyclic delay diversity scheme as described herein. For example, the communications manager 1020 may include a CDD range indication component 1025, a CDD selection component 1030, a CDD signaling reception component 1035, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The CDD range indication component 1025 is capable of, configured to, or operable to support a means for receiving first control signaling that indicates a range of values for a CDD parameter associated with a control channel between a network entity and the UE. The CDD selection component 1030 is capable of, configured to, or operable to support a means for selecting a value of the CDD parameter from the indicated range of values for the CDD parameter. The CDD signaling reception component 1035 is capable of, configured to, or operable to support a means for receiving second control signaling via the control channel based on the value of the CDD parameter.

In some examples, to support receiving the first control signaling that indicates the range of values, the CDD range indication component 1025 is capable of, configured to, or operable to support a means for receiving an indication of a lower bound value, an upper bound value, or both, associated with the range of values for the CDD parameter.

In some examples, to support receiving the first control signaling that indicates the range of values, the CDD range indication component 1025 is capable of, configured to, or operable to support a means for receiving an indication of a mean value and of an uncertainty value, where the mean value and the uncertainty value together indicate the range of values.

In some examples, the CDD range indication component 1025 is capable of, configured to, or operable to support a means for receiving third control signaling that indicates a set of multiple ranges of values for the CDD parameter, where the first control signaling indicates the range of values from the set of multiple ranges of values.

In some examples, each range of values of the set of multiple ranges of values for the CDD parameter corresponds to one or more channel conditions. In some examples, the one or more channel conditions include a channel delay associated with the control channel, an aggregation level associated with the control channel, a size of a control resource set of the control channel, or any combination thereof.

In some examples, the first control signaling includes a medium access control-control element (MAC-CE), an RRC message, a DCI message, or a combination thereof.

In some examples, the range of values for the CDD parameter corresponds to one or more control resource sets, one or more search space sets, one or more search space set groups, one or more aggregation levels, or any combination thereof, associated with the control channel.

In some examples, the value of the CDD parameter is selected from the indicated range of values for the CDD parameter based on one or more configurations, one or more measurements, or both, associated with the control channel.

In some examples, the range of values for the CDD parameter is based on a channel delay characteristic associated with the control channel, a code rate associated with the control channel, one or more wireless communication resources allocated for the control channel, or any combination thereof.

In some examples, to support receiving the second control signaling based on the value of the CDD parameter, the CDD signaling reception component 1035 is capable of, configured to, or operable to support a means for receiving the second control signaling via one or more resource elements of the control channel, where each resource element of the control channel is associated with a respective phase shift based on the range of values for the CDD parameter.

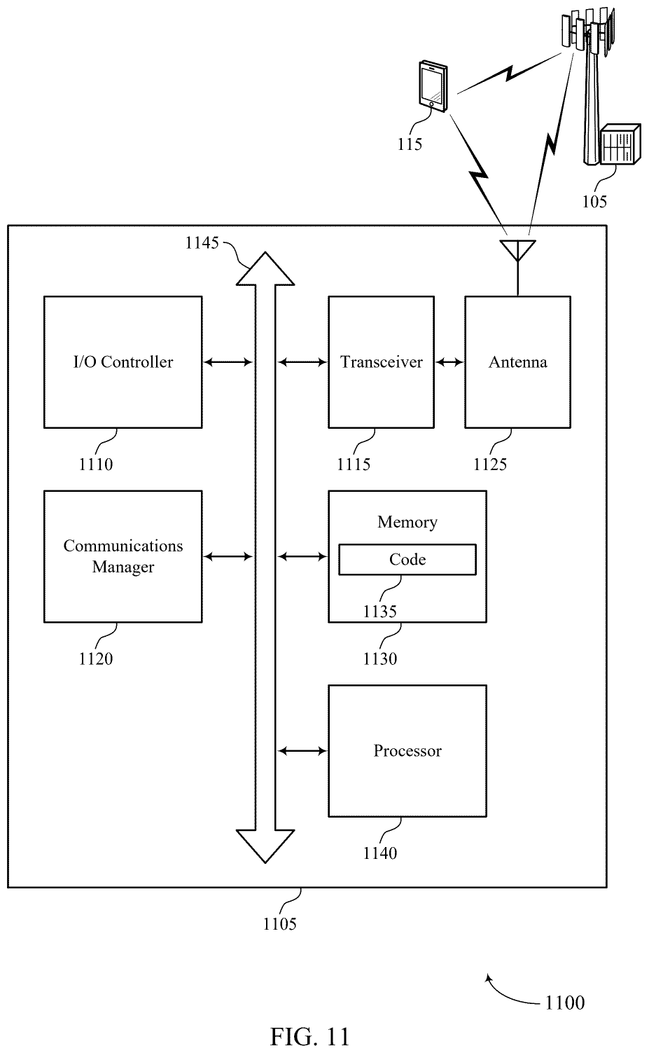

FIG. 11 shows a diagram of a system 1100 including a device 1105 that supports a control channel CDD scheme in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting control channel cyclic delay diversity scheme). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first control signaling that indicates a range of values for a CDD parameter associated with a control channel between a network entity and the UE. The communications manager 1120 is capable of, configured to, or operable to support a means for selecting a value of the CDD parameter from the indicated range of values for the CDD parameter. The communications manager 1120 is capable of, configured to, or operable to support a means for receiving second control signaling via the control channel based on the value of the CDD parameter.

By including or configuring the communications manager 1120 in accordance with examples as described herein, the device 1105 may support techniques for reduced power consumption and more efficient utilization of communication resources. For example, a UE 115 implementing the semi-transparent CDD scheme described herein may experience increased diversity gain associated with control signaling while maintaining a low signaling overhead for the semi-transparent CDD scheme, which may reduce signaling and power usage at the UE 115.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of control channel cyclic delay diversity scheme as described herein, or the at least one processor 1140 and the at least one memory 1130 may be otherwise configured to, individually or collectively, perform or support such operations.

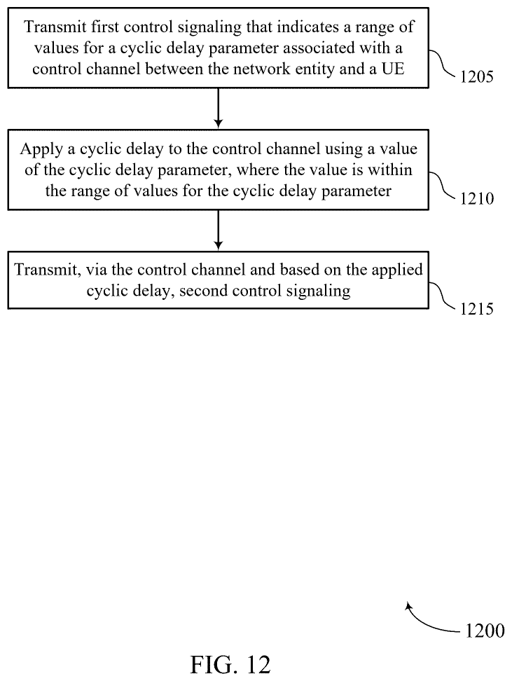

FIG. 12 shows a flowchart illustrating a method 1200 that supports a control channel CDD scheme in accordance with one or more aspects of the present disclosure. The operations of the method 1200 may be implemented by a network entity or its components as described herein. For example, the operations of the method 1200 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1205, the method may include transmitting first control signaling that indicates a range of values for a CDD parameter associated with a control channel between the network entity and a UE. The operations of 1205 may be performed in accordance with examples as disclosed herein. In some examples, aspects of the operations of 1205 may be performed by a CDD range indication component 625 as described with reference to FIG. 6.

At 1210, the method may include applying a cyclic delay to the control channel using a value of the CDD parameter, where the value is within the range of values for the CDD parameter. The operations of 1210 may be performed in accordance with examples as disclosed herein. In some examples, aspects of the operations of 1210 may be performed by a cyclic delay application component 630 as described with reference to FIG. 6.

At 1215, the method may include transmitting, via the control channel and based on the applied cyclic delay, second control signaling. The operations of 1215 may be performed in accordance with examples as disclosed herein. In some examples, aspects of the operations of 1215 may be performed by a CDD signaling transmission component 635 as described with reference to FIG. 6.

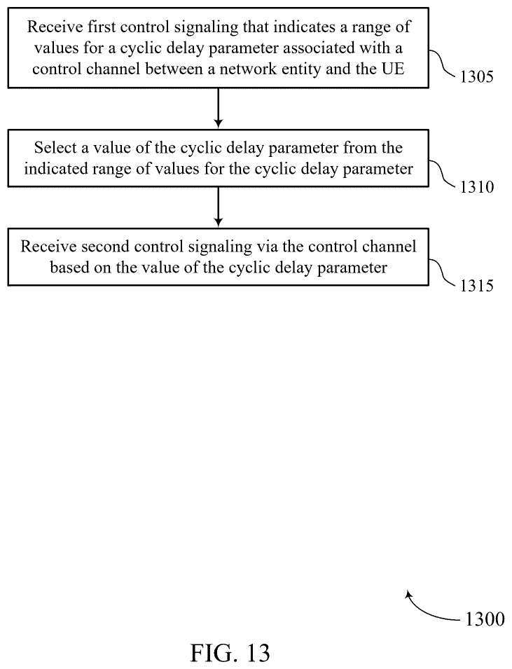

FIG. 13 shows a flowchart illustrating a method 1300 that supports a control channel CDD scheme in accordance with one or more aspects of the present disclosure. The operations of the method 1300 may be implemented by a UE or its components as described herein. For example, the operations of the method 1300 may be performed by a UE 115 as described with reference to FIGS. 1 through 3 and 8 through 11. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling that indicates a range of values for a CDD parameter associated with a control channel between a network entity and the UE. The operations of 1305 may be performed in accordance with examples as disclosed herein. In some examples, aspects of the operations of 1305 may be performed by a CDD range indication component 1025 as described with reference to FIG. 10.

At 1310, the method may include selecting a value of the CDD parameter from the indicated range of values for the CDD parameter. The operations of 1310 may be performed in accordance with examples as disclosed herein. In some examples, aspects of the operations of 1310 may be performed by a CDD selection component 1030 as described with reference to FIG. 10.

At 1315, the method may include receiving second control signaling via the control channel based on the value of the CDD parameter. The operations of 1315 may be performed in accordance with examples as disclosed herein. In some examples, aspects of the operations of 1315 may be performed by a CDD signaling reception component 1035 as described with reference to FIG. 10.

The following provides an overview of aspects of the present disclosure:

Aspect 1: A method for wireless communications at a network entity, comprising: transmitting first control signaling that indicates a range of values for a CDD parameter associated with a control channel between the network entity and a UE; applying a cyclic delay to the control channel using a value of the CDD parameter, wherein the value is within the range of values for the CDD parameter; and transmitting, via the control channel and based at least in part on the applied cyclic delay, second control signaling.

Aspect 2: The method of aspect 1, wherein transmitting the first control signaling that indicates the range of values comprises: transmitting an indication of a lower bound value, an upper bound value, or both, associated with the range of values for the CDD parameter.

Aspect 3: The method of aspect 1, wherein transmitting the first control signaling that indicates the range of values comprises: transmitting an indication of a mean value and of an uncertainty value, wherein the mean value and the uncertainty value together indicate the range of values.

Aspect 4: The method of any of aspects 1 through 3, further comprising: transmitting third control signaling that indicates a plurality of ranges of values for the CDD parameter, wherein the first control signaling indicates the range of values from the plurality of ranges of values.

Aspect 5: The method of aspect 4, wherein each range of values of the plurality of ranges of values for the CDD parameter corresponds to one or more channel conditions, and the one or more channel conditions comprise a channel delay associated with the control channel, an aggregation level associated with the control channel, a size of a control resource set of the control channel, or any combination thereof.

Aspect 6: The method of aspect 5, further comprising: performing a range selection procedure to obtain the plurality of ranges of values based at least in part on the one or more channel conditions of the control channel within a time window, wherein the first control signaling is transmitted based at least in part on the range selection procedure.

Aspect 7: The method of any of aspects 1 through 6, wherein the first control signaling comprises a MAC-CE, an RRC message, a DCI message, or a combination thereof.

Aspect 8: The method of any of aspects 1 through 7, wherein the range of values for the CDD parameter corresponds to one or more control resource sets, one or more search space sets, one or more search space set groups, one or more aggregation levels, or any combination thereof, associated with the control channel.

Aspect 9: The method of any of aspects 1 through 8, wherein the range of values for the CDD parameter is based at least in part on a channel delay characteristic associated with the control channel, a code rate associated with the control channel, one or more wireless communication resources allocated for the control channel, or any combination thereof.

Aspect 10: The method of any of aspects 1 through 9, wherein transmitting the second control signaling via the control channel based at least in part on the applied cyclic delay comprises: transmitting the second control signaling via one or more resource elements of the control channel, wherein each resource element of the control channel is associated with a respective phase shift based at least in part on the value of the CDD parameter.

Aspect 11: A method for wireless communications at a UE, comprising: receiving first control signaling that indicates a range of values for a CDD parameter associated with a control channel between a network entity and the UE; selecting a value of the CDD parameter from the indicated range of values for the CDD parameter; and receiving second control signaling via the control channel based at least in part on the value of the CDD parameter.

Aspect 12: The method of aspect 11, wherein receiving the first control signaling that indicates the range of values comprises: receiving an indication of a lower bound value, an upper bound value, or both, associated with the range of values for the CDD parameter.

Aspect 13: The method of aspect 11, wherein receiving the first control signaling that indicates the range of values comprises: receiving an indication of a mean value and of an uncertainty value, wherein the mean value and the uncertainty value together indicate the range of values.

Aspect 14: The method of any of aspects 11 through 13, further comprising: receiving third control signaling that indicates a plurality of ranges of values for the CDD parameter, wherein the first control signaling indicates the range of values from the plurality of ranges of values.

Aspect 15: The method of aspect 14, wherein each range of values of the plurality of ranges of values for the CDD parameter corresponds to one or more channel conditions, and the one or more channel conditions comprise a channel delay associated with the control channel, an aggregation level associated with the control channel, a size of a control resource set of the control channel, or any combination thereof.

Aspect 16: The method of any of aspects 11 through 15, wherein the first control signaling comprises a MAC-CE, an RRC message, a DCI message, or a combination thereof.

Aspect 17: The method of any of aspects 11 through 16, wherein the range of values for the CDD parameter corresponds to one or more control resource sets, one or more search space sets, one or more search space set groups, one or more aggregation levels, or any combination thereof, associated with the control channel.

Aspect 18: The method of any of aspects 11 through 17, wherein the value of the CDD parameter is selected from the indicated range of values for the CDD parameter based at least in part on one or more configurations, one or more measurements, or both, associated with the control channel.

Aspect 19: The method of any of aspects 11 through 18, wherein the range of values for the CDD parameter is based at least in part on a channel delay characteristic associated with the control channel, a code rate associated with the control channel, one or more wireless communication resources allocated for the control channel, or any combination thereof.

Aspect 20: The method of any of aspects 11 through 19, wherein receiving the second control signaling based at least in part on the value of the CDD parameter comprises: receiving the second control signaling via one or more resource elements of the control channel, wherein each resource element of the control channel is associated with a respective phase shift based at least in part on the range of values for the CDD parameter.

Aspect 21: A network entity for wireless communications, comprising one or more memories storing processor-executable code, and one or more processors coupled with the one or more memories and individually or collectively operable to execute the code to cause the network entity to perform a method of any of aspects 1 through 10.

Aspect 22: A network entity for wireless communications, comprising at least one means for performing a method of any of aspects 1 through 10.

Aspect 23: A non-transitory computer-readable medium storing code for wireless communications, the code comprising instructions executable by one or more processors to perform a method of any of aspects 1 through 10.

Aspect 24: A UE for wireless communications, comprising one or more memories storing processor-executable code, and one or more processors coupled with the one or more memories and individually or collectively operable to execute the code to cause the UE to perform a method of any of aspects 11 through 20.

Aspect 25: A UE for wireless communications, comprising at least one means for performing a method of any of aspects 11 through 20.

Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
transmit first control signaling that indicates a range of values for a cyclic delay parameter associated with a control channel between the network entity and a user equipment (UE);
apply a cyclic delay to the control channel using a value of the cyclic delay parameter, wherein the value is within the range of values for the cyclic delay parameter; and
transmit, via the control channel and based at least in part on the applied cyclic delay, second control signaling.

2. The network entity of claim 1, wherein, to transmit the first control signaling that indicates the range of values, the one or more processors are individually or collectively operable to execute the code to cause the network entity to:
transmit an indication of a lower bound value, an upper bound value, or both, associated with the range of values for the cyclic delay parameter.

3. The network entity of claim 1, wherein, to transmit the first control signaling that indicates the range of values, the one or more processors are individually or collectively operable to execute the code to cause the network entity to:
transmit an indication of a mean value and of an uncertainty value, wherein the mean value and the uncertainty value together indicate the range of values.

4. The network entity of claim 1, wherein the one or more processors are individually or collectively further operable to execute the code to cause the network entity to:
transmit third control signaling that indicates a plurality of ranges of values for the cyclic delay parameter, wherein the first control signaling indicates the range of values from the plurality of ranges of values.

5. The network entity of claim 4, wherein:
each range of values of the plurality of ranges of values for the cyclic delay parameter corresponds to one or more channel conditions, and
the one or more channel conditions comprise a channel delay associated with the control channel, an aggregation level associated with the control channel, a size of a control resource set of the control channel, or any combination thereof.

6. The network entity of claim 5, wherein the one or more processors are individually or collectively further operable to execute the code to cause the network entity to:
perform a range selection procedure to obtain the plurality of ranges of values based at least in part on the one or more channel conditions of the control channel within a time window, wherein the first control signaling is transmitted based at least in part on the range selection procedure.

7. The network entity of claim 1, wherein the first control signaling comprises a medium access control-control element (MAC-CE), a radio resource control (RRC) message, a downlink control information (DCI) message, or a combination thereof.

8. The network entity of claim 1, wherein the range of values for the cyclic delay parameter corresponds to one or more control resource sets, one or more search space sets, one or more search space set groups, one or more aggregation levels, or any combination thereof, associated with the control channel.

9. The network entity of claim 1, wherein the range of values for the cyclic delay parameter is based at least in part on a channel delay characteristic associated with the control channel, a code rate associated with the control channel, one or more wireless communication resources allocated for the control channel, or any combination thereof.

10. The network entity of claim 1, wherein, to transmit the second control signaling via the control channel based at least in part on the applied cyclic delay, the one or more processors are individually or collectively operable to execute the code to cause the network entity to:
transmit the second control signaling via one or more resource elements of the control channel, wherein each resource element of the control channel is associated with a respective phase shift based at least in part on the value of the cyclic delay parameter.

11. A user equipment (UE), comprising:
one or more memories storing processor-executable code; and
one or more processors coupled with the one or more memories and individually or collectively operable to execute the code to cause the UE to:
receive first control signaling that indicates a range of values for a cyclic delay parameter associated with a control channel between a network entity and the UE;
select a value of the cyclic delay parameter from the indicated range of values for the cyclic delay parameter; and
receive second control signaling via the control channel based at least in part on the value of the cyclic delay parameter.

12. The UE of claim 11, wherein, to receive the first control signaling that indicates the range of values, the one or more processors are individually or collectively operable to execute the code to cause the UE to:
receive an indication of a lower bound value, an upper bound value, or both, associated with the range of values for the cyclic delay parameter.

13. The UE of claim 11, wherein, to receive the first control signaling that indicates the range of values, the one or more processors are individually or collectively operable to execute the code to cause the UE to:
receive an indication of a mean value and of an uncertainty value, wherein the mean value and the uncertainty value together indicate the range of values.

14. The UE of claim 11, wherein the one or more processors are individually or collectively further operable to execute the code to cause the UE to:
receive third control signaling that indicates a plurality of ranges of values for the cyclic delay parameter, wherein the first control signaling indicates the range of values from the plurality of ranges of values.

15. The UE of claim 14, wherein:
each range of values of the plurality of ranges of values for the cyclic delay parameter corresponds to one or more channel conditions, and
the one or more channel conditions comprise a channel delay associated with the control channel, an aggregation level associated with the control channel, a size of a control resource set of the control channel, or any combination thereof.

16. The UE of claim 11, wherein the first control signaling comprises a medium access control-control element (MAC-CE), a radio resource control (RRC) message, a downlink control information (DCI) message, or a combination thereof.

17. The UE of claim 11, wherein the range of values for the cyclic delay parameter corresponds to one or more control resource sets, one or more search space sets, one or more search space set groups, one or more aggregation levels, or any combination thereof, associated with the control channel.

18. The UE of claim 11, wherein the value of the cyclic delay parameter is selected from the indicated range of values for the cyclic delay parameter based at least in part on one or more configurations, one or more measurements, or both, associated with the control channel.

19. The UE of claim 11, wherein the range of values for the cyclic delay parameter is based at least in part on a channel delay characteristic associated with the control channel, a code rate associated with the control channel, one or more wireless communication resources allocated for the control channel, or any combination thereof.

20. The UE of claim 11, wherein, to receive the second control signaling based at least in part on the value of the cyclic delay parameter, the one or more processors are individually or collectively operable to execute the code to cause the UE to:
receive the second control signaling via one or more resource elements of the control channel, wherein each resource element of the control channel is associated with a respective phase shift based at least in part on the range of values for the cyclic delay parameter.

21. A method for wireless communications at a network entity, comprising:
transmitting first control signaling that indicates a range of values for a cyclic delay parameter associated with a control channel between the network entity and a user equipment (UE);
applying a cyclic delay to the control channel using a value of the cyclic delay parameter, wherein the value is within the range of values for the cyclic delay parameter; and
transmitting, via the control channel and based at least in part on the applied cyclic delay, second control signaling.

22. The method of claim 21, wherein transmitting the first control signaling that indicates the range of values comprises:
transmitting an indication of a lower bound value, an upper bound value, or both, associated with the range of values for the cyclic delay parameter.

23. The method of claim 21, wherein transmitting the first control signaling that indicates the range of values comprises:
transmitting an indication of a mean value and of an uncertainty value, wherein the mean value and the uncertainty value together indicate the range of values.

24. The method of claim 21, further comprising:
transmitting third control signaling that indicates a plurality of ranges of values for the cyclic delay parameter, wherein the first control signaling indicates the range of values from the plurality of ranges of values.

25. The method of claim 24, wherein each range of values of the plurality of ranges of values for the cyclic delay parameter corresponds to one or more channel conditions, and wherein the one or more channel conditions comprise a channel delay associated with the control channel, an aggregation level associated with the control channel, a size of a control resource set of the control channel, or any combination thereof.

26. The method of claim 25, further comprising:
performing a range selection procedure to obtain the plurality of ranges of values based at least in part on the one or more channel conditions of the control channel within a time window, wherein the first control signaling is transmitted based at least in part on the range selection procedure.

27. The method of claim 21, wherein the first control signaling comprises a medium access control-control element (MAC-CE), a radio resource control (RRC) message, a downlink control information (DCI) message, or a combination thereof.

28. The method of claim 21, wherein the range of values for the cyclic delay parameter corresponds to one or more control resource sets, one or more search space sets, one or more search space set groups, one or more aggregation levels, or any combination thereof, associated with the control channel.

29. The method of claim 21, wherein the range of values for the cyclic delay parameter is based at least in part on a channel delay characteristic associated with the control channel, a code rate associated with the control channel, one or more wireless communication resources allocated for the control channel, or any combination thereof.

30. A method for wireless communications at a user equipment (UE), comprising:
receiving first control signaling that indicates a range of values for a cyclic delay parameter associated with a control channel between a network entity and the UE;
selecting a value of the cyclic delay parameter from the indicated range of values for the cyclic delay parameter; and
receiving second control signaling via the control channel based at least in part on the value of the cyclic delay parameter.
